(19) United States
(12) Patent Application Publication
(10) Pub. No.: US 2026/0254066 A1
(43) Pub. Date: Aug. 27, 2026

(54) ALL-SOLID-STATE RECHARGEABLE BATTERY

(71) Applicant: SAMSUNG SDI CO., LTD., Yongin-si, Gyeonggi-do (KR)

(72) Inventors: Kyeongsu LEE, Yongin-si, Gyeonggi-do (KR); Youngjun LIM, Yongin-si, Gyeonggi-do (KR); Hyungsub LEE, Yongin-si, Gyeonggi-do (KR); Junghwan PARK, Yongin-si, Gyeonggi-do (KR); Young Gyoon RYU, Yongin-si, Gyeonggi-do (KR)

(21) Appl. No.: 18/874,753

(22) PCT Filed: Jan. 5, 2024
(86) PCT No.: PCT/KR2024/000263

§ 371 Date: Dec. 13, 2024

(30) Foreign Application Priority Data
Jun. 20, 2023 (KR) 10-2023-0079272

(51) Int. Cl. H01M 50/569; H01M 10/0562; H01M 10/0585; H01M 10/48; H01M 50/184; H01M 50/186; H01M 50/457; H01M 50/463; H01M 50/593; H01M 50/595

(52) U.S. Cl. CPC H01M 50/569; H01M 10/0562; H01M 10/0585; H01M 10/48; H01M 50/184; H01M 50/186; H01M 50/457; H01M 50/463; H01M 50/593; H01M 50/595

(57) ABSTRACT

An all-solid-state rechargeable battery includes a first electrode; a second electrode positioned on the first electrode; a first solid electrolyte layer positioned between the first electrode and the second electrode; and a reference electrode corresponding to the end of the first solid electrolyte layer.

### TECHNICAL FIELD

The disclosure relates to an all-solid-state rechargeable battery.

### BACKGROUND ART

Recent reports of explosions in batteries using liquid electrolytes have led to development of all-solid-state rechargeable batteries. The all-solid-state rechargeable battery, a battery in which all materials are solid, uses solid electrolytes.

These all-solid-state rechargeable batteries are safe because there is no risk of explosion due to an electrolyte leakage, and they have the advantage of being easily manufactured in a thin form.

The all-solid-state rechargeable battery includes a first electrode, a second electrode, and a solid electrolyte layer positioned between the first and second electrodes.

In the conventional all-solid-state rechargeable battery, the potential of the first electrode, which may be a working electrode, and the second electrode, which may be a counter electrode, change during charging and discharging, making it difficult to measure the potential of each electrode.

### DISCLOSURE

### Technical Problem

An embodiment seeks to provide an all-solid-state rechargeable battery including a reference electrode capable of accurately measuring potentials of positive and negative electrodes simultaneously while suppressing short circuiting with other electrodes.

### Technical Solution

An all-solid-state rechargeable battery including a first electrode; a second electrode positioned on the first electrode; a first solid electrolyte layer positioned between the first electrode and the second electrode; and a reference electrode corresponding to an end of the first solid electrolyte layer is provided.

The reference electrode may overlap the end of the first solid electrolyte layer in the vertical direction in which the first electrode, the first solid electrolyte layer, and the second electrode overlap each other.

The reference electrode may not overlap the central region of the first solid electrolyte layer in the vertical direction.

A second solid electrolyte layer positioned between the first solid electrolyte layer and the second electrode may be further included.

The reference electrode may be positioned between the end of the first solid electrolyte layer and the end of the second solid electrolyte layer.

The reference electrode may include an insulating tape adjacent to the end of the first solid electrolyte layer and the end of the second solid electrolyte layer.

A third electrode positioned on the second electrode, and a third solid electrolyte layer positioned between the second electrode and the third electrode may be further included.

A first gasket surrounding the rim of the second electrode may be further included.

The reference electrode may be in contact with the first gasket between the end of the first solid electrolyte layer and the end of the third solid electrolyte layer.

The reference electrode may be spaced apart from the second electrode.

The third solid electrolyte layer may include a first extension extending from the rear surface of the third electrode opposite the second electrode through the end of the third electrode to the front surface of the third electrode, and the reference electrode may be positioned on the first extension.

The reference electrode may be in contact with the first extension.

The first solid electrolyte layer may include a second extension extending from the rear surface of the second electrode opposite the first electrode through the end of the second electrode to the front surface of the second electrode, and the reference electrode may be positioned on the second extension.

The reference electrode may be in contact with the second extension.

A second gasket surrounding the rim of the first electrode may be further included.

The first solid electrolyte layer may include a tail extending in a horizontal direction intersecting the vertical direction in which the first electrode, the first solid electrolyte layer, and the second electrode overlap each other.

The reference electrode may be in contact with the tail.

The tail may include a cutting line.

The first electrode may be a positive electrode.

The first electrode may be a negative electrode.

### Advantageous Effects

According to an embodiment, the all-solid-state rechargeable battery is provided which includes the reference electrode capable of accurately measuring the potential of the positive and negative electrodes simultaneously while suppressing short circuiting with the other electrodes.

### DESCRIPTION OF THE DRAWINGS

FIG. 1 is a cross-sectional view of an all-solid-state battery.

FIG. 2 is a cross-sectional view of an all-solid-state battery including a precipitated negative electrode.

FIG. 3 is a cross-sectional view showing an all-solid-state rechargeable battery according to an embodiment.

FIG. 4 is a cross-sectional view showing an all-solid-state rechargeable battery according to another embodiment.

FIG. 5 is a cross-sectional view showing an all-solid-state rechargeable battery according to another embodiment.

FIG. 6 is a cross-sectional view showing an all-solid-state rechargeable battery according to another embodiment.

FIG. 7 is a cross-sectional view showing an all-solid-state rechargeable battery according to another embodiment.

FIG. 8 is a cross-sectional view showing an all-solid-state rechargeable battery according to another embodiment.

### MODE FOR INVENTION

Hereinafter, some exemplary embodiments of the present invention are described in detail with reference to the accompanying drawings in order for those skilled in the art to be able to readily practice the exemplary embodiments. As those skilled in the art would realize, the described embodiments may be modified in various different ways, all without departing from the spirit or scope of the present invention.

In addition, unless explicitly stated to the contrary, the word “comprise,” and variations such as “comprises” and “comprising,” should be understood to imply the inclusion of stated elements but not the exclusion of any other elements.

In order to clearly express multiple layers and regions in the drawings, the thickness is enlarged and shown, and like reference numerals designate like elements throughout the specification. It should be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on a whole surface when seen from a plan view, but also a shape formed on a partial surface. Herein, “or” is not to be construed as having an exclusive meaning—for example, “A or B” is construed to include A, B, A+B, and the like.

Positive Electrodes for all-Solid-State Rechargeable Batteries

In an embodiment, as a positive electrode for an all-solid-state rechargeable battery including a current collector and a positive active material layer positioned on the current collector, the positive electrode for the all-solid-state rechargeable battery including the positive active material layer having a positive active material, a sulfide-based solid electrolyte, a fluorinated resin binder, and vanadium oxide is provided.

The positive electrode for the all-solid-state rechargeable battery is manufactured by coating a positive electrode composition including the positive active material, the sulfide-based solid electrolyte, the fluorinated resin binder, and vanadium oxide to the current collector, and then drying and rolling.

The positive electrode composition is generally strongly alkaline due to residual lithium such as LiOH or other components, which may cause gelation or coagulation of the fluorinated resin binder. However, according to an embodiment, by adding vanadium oxide, gelation of the fluorinated resin binder may be suppressed, and thus viscosity of the positive electrode composition may be maintained, thereby ensuring processability. In addition, since there is no need to use a neutralization agent, etc., the degradation of the sulfide-based solid electrolyte due to the neutralization agent may be prevented, thereby improving the performance of the all-solid-state rechargeable battery.

### Vanadium Oxide

Vanadium oxide is a solvent-insoluble component of the positive electrode composition, which controls the strong basicity of the positive electrode composition, thereby preventing gelation of the fluorinated resin binder and simultaneously suppressing degradation of the sulfide-based solid electrolyte, thereby improving ion conductivity of the positive electrode. Vanadium oxide is understood to control pH through physical and/or chemical reactions with —OH groups in the positive electrode composition of a strongly basic state, thereby suppressing gelation of the fluorinated resin binder. Vanadium oxide has better ability to suppress gelation of the fluorinated resin binder by controlling basicity than other transition metal oxides such as titanium oxide or tungsten oxide, has low reactivity with sulfide-based solid electrolytes, and suppresses degradation of the sulfide-based solid electrolytes, thereby improving ion conductivity of the all-solid-state rechargeable batteries and enhancing the overall performance thereof.

Vanadium oxide, for example, may include V₂O₃, VO₂, V₂O₄, V₂O₅, or combinations thereof. Additionally, vanadium oxide may be included in an amount of 0.01 wt % to 5 wt % with respect to 100 wt % of the positive active material layer—for example, 0.05 wt % to 5 wt %, 0.1 wt % to 5 wt %, 0.5 wt % to 5 wt %, or 0.5 wt % to 3 wt %. When vanadium oxide is included in such a content, the viscosity of the positive electrode composition may be appropriately maintained without capacity deterioration, thereby improving processability and enhancing ion conductivity of the positive electrode.

According to an embodiment, since the positive electrode composition is coated on the current collector while vanadium oxide is added to the positive electrode composition and dispersed therein, vanadium oxide may be dispersed within the manufactured positive active material layer. This is distinct from the form in which vanadium oxide is coated on the surface of the positive active material or the sulfide-based solid electrolyte.

In one example, vanadium oxide may be a pentavalent vanadium oxide (vanadium (V) oxide), in which case, a melting point of vanadium oxide may be less than 1000° C.—for example, 600° C. to 800° C., or 650° C. to 690° C. Pentavalent vanadium oxide is excellent in suppressing the gelation of the fluorinated resin binder within the positive electrode and is advantageous in improving the overall performance of the battery.

Additionally, vanadium oxide may be in a form of particles and the average particle diameter D50 may be from 10 nm to 10 μm—for example, from 10 nm to 5 μm, from 10 nm to 3 μm, from 50 nm to 1 μm, from 50 nm to 500 nm, or from 500 nm to 1 μm. Vanadium oxide with these properties is suitable for inclusion in the positive electrode composition, and may effectively suppress gelation of the positive electrode composition without adversely affecting the positive electrode. If the particle diameter of vanadium oxide is too small, it may not disperse properly within the positive electrode, blocking the passage of electrons and ions, which may degrade battery performance, or it may not be able to sufficiently suppress gelation of the binder. Conversely, if the particle diameter of vanadium oxide is too large, it may block the passage of electrons and ions, which may degrade battery performance.

### Fluorinated Resin Binder

The fluorinated resin binder may be a general resin binder including fluorine, and may include, for example, polyvinylidene fluoride, polyvinylidene fluoride-hexafluoropropylene copolymer, polyvinylidene fluoride-trichloroethylene copolymer, polyvinylidene fluoride-chlorotrifluoroethylene copolymer, polytetrafluoroethylene, or a combination thereof.

The weight average molecular weight of the fluorinated resin binder may be approximately 50 kDa to 5,000 kDa, or 100 kDa to 2,000 kDa. Additionally, the glass transition temperature of the fluorinated resin binder may be below—10° C., and the melting point may be above 100° C. The melting viscosity of the fluorinated resin binder may be about 10 kP to 50 kP. Additionally, the fluorinated resin binder may be in a form of particles, and the average particle diameter thereof may be approximately 50 nm to 200 μm. The fluorinated resin binder with these properties may achieve excellent adhesion even when added in small amounts to the positive electrode composition, and may increase durability of the battery without adversely affecting battery performance.

The fluorinated resin binder may be included in an amount of 0.1 wt % to 10 wt % with respect to 100 wt % of the positive active material layer—for example, 0.1 wt % to 8 wt %, 0.1 wt % to 6 wt %, 0.1 wt % to 5 wt %, 0.5 wt % to 4 wt %, or 1 wt % to 3 wt %. When the fluorinated resin binder is included in these content ranges, excellent adhesion may be exhibited without adversely affecting the positive electrode.

### Positive Active Material

The positive active materials may be applied without limitation as long as they are generally used in all-solid-state rechargeable batteries. For example, the positive active material may be a compound capable of reversible intercalation and deintercalation of lithium, and may include a compound expressed by any of the following chemical formulas.

$${Li}_{a} {A}_{1 - b} {X}_{b} {D}_{2} ( 0.9 \leq a \leq 1.8 , 0 \leq b \leq 0.5 ) ;$$

$${Li}_{a} {A}_{1 - b} {X}_{b} {O}_{2 - c} {D}_{c} ( 0.9 \leq a \leq 1.8 , 0 \leq b \leq 0.5 , 0 \leq c \leq 0.05 ) ;$$

$${Li}_{a} {E}_{1 - b} {X}_{b} {O}_{2 - c} {D}_{c} ( 0.9 \leq a \leq 1.8 , 0 \leq b \leq 0.5 , 0 \leq c \leq 0.05 ) ;$$

$${Li}_{a} {E}_{2 - b} {X}_{b} {O}_{4 - c} {D}_{c} ( 0.9 \leq a \leq 1.8 , 0 \leq b \leq 0.5 , 0 \leq c \leq 0.05 ) ;$$

$${Li}_{a} {Ni}_{1 - b - c} {Co}_{b} {X}_{c} {D}_{α} ( 0.9 \leq a \leq 1.8 , 0 \leq b \leq 0.5 , 0 \leq c \leq 0.5 , 0 < α \leq 2 ) ;$$

$${Li}_{a} {Ni}_{1 - b - c} {Co}_{b} {X}_{c} {O}_{2 - α} {T}_{α} ( 0.9 \leq a \leq 1.8 , 0 \leq b \leq 0.5 , 0 \leq c \leq 0.05 , 0 < α \leq 2 ) ;$$

$${Li}_{a} {Ni}_{1 - b - c} {Co}_{b} {X}_{c} {O}_{2 - α} {T}_{2} ( 0.9 \leq a \leq 1.8 , 0 \leq b \leq 0.5 , 0 \leq c \leq 0.05 , 0 < α \leq 2 ) ;$$

$${Li}_{a} {Ni}_{1 - b - c} {Mn}_{b} {X}_{c} {D}_{α} ( 0.9 \leq a \leq 1.8 , 0 \leq b \leq 0.5 , 0 \leq c \leq 0.05 , 0 < α \leq 2 ) ;$$

$${Li}_{a} {Ni}_{1 - b - c} {Mn}_{b} {X}_{c} {O}_{2 - α} {T}_{α} ( 0.9 \leq a \leq 1.8 , 0 \leq b \leq 0.5 , 0 \leq c \leq 0.05 , 0 < α \leq 2 ) ;$$

$${Li}_{a} {Ni}_{1 - b - c} {Mn}_{b} {X}_{c} {O}_{2 - α} {T}_{2} ( 0.9 \leq a \leq 1.8 , 0 \leq b \leq 0.5 , 0 \leq c \leq 0.05 , 0 < α \leq 2 ) ;$$

$${Li}_{a} {Ni}_{b} {E}_{c} {G}_{d} {O}_{2} ( 0.9 \leq a \leq 1.8 , 0 \leq b \leq 0.9 , 0 \leq c \leq 0.5 , 0.001 \leq d \leq 0.1 ) ;$$

$${Li}_{a} {Ni}_{b} {Co}_{c} {Mn}_{d} {G}_{e} {O}_{2} ( 0.9 \leq a \leq 1.8 , 0 \leq b \leq 0.9 , 0 \leq c \leq 0.5 , 0 \leq d \leq 0.5 , 0.001 \leq e \leq 0.1 ) ;$$

$${Li}_{a} Ni {G}_{b} {O}_{2} ( 0.9 \leq a \leq 1.8 , 0.001 \leq b \leq 0.1 ) ;$$

$${Li}_{a} {Co G}_{b} {O}_{2} ( 0.9 \leq a \leq 1.8 , 0.001 \leq b \leq 0.1 ) ;$$

$${Li}_{a} {Mn}_{1 - b} {G}_{b} {O}_{2} ( 0.9 \leq a \leq 1.8 , 0.001 \leq b \leq 0.1 ) ;$$

$${Li}_{a} {Mn}_{2} {G}_{b} {O}_{4} ( 0.9 \leq a \leq 1.8 , 0.001 \leq b \leq 0.1 ) ;$$

$${Li}_{a} {Mn}_{1 - g} {G}_{g} {PO}_{4} ( 0.9 \leq a \leq 1.8 , 0 \leq g \leq 0.5 ) ;$$

$${Q O}_{2} ; {Q S}_{2} ; {Li Q S}_{2} ;$$

$${V}_{2} {O}_{5} ; {LiV}_{2} {O}_{5} ;$$

$${Li Z O}_{2} ;$$

$${LiNiVO}_{4} ;$$

$${Li}_{( 3 - f )} {J}_{2} {PO}_{43} ( 0 \leq f \leq 2 ) ;$$

$${Li}_{( 3 - f )} {Fe}_{2} {PO}_{43} ( 0 \leq f \leq 2 ) ;$$

$${Li}_{a} {FePO}_{4} ( 0.91 \leq a \leq 1.8 ) .$$

In the above chemical formulas, A is selected from the group consisting of Ni, Co, Mn, and a combination thereof; X is selected from the group consisting of Al, Ni, Co, Mn, Cr, Fe, Mg, Sr, V, a rare earth element, and a combination thereof; D is selected from the group consisting of O, F, S, P, and a combination thereof; E is selected from the group consisting of Co, Mn, and a combination thereof; T is selected from the group consisting of F, S, P, and a combination thereof; G is selected from the group consisting of Al, Cr, Mn, Fe, Mg, La, Ce, Sr, V, and a combination thereof; Q is selected from the group consisting of Ti, Mo, Mn, and a combination thereof; Z is selected from the group consisting of Cr, V, Fe, Sc, Y, and a combination thereof; and J is selected from the group consisting of V, Cr, Mn, Co, Ni, Cu, and a combination thereof.

The positive active materials, for example, may be lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), or lithium iron phosphate oxide (LFP), etc.

The positive active material may include a lithium nickel-based oxide represented by Chemical Formula 1 below, a lithium cobalt-based oxide represented by Chemical Formula 2 below, a lithium phosphoric acid iron-based compound represented by Chemical Formula 3 below, or a combination thereof.

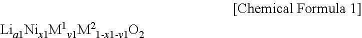

In Chemical Formula 1, 0.9≤a1≤1.8, 0.3≤x1≤1, 0≤y1≤0.7, and M¹ and M² are each independently one or more elements selected from a group including Al, B, Ba, Ca, Ce, Co, Cr, Cu, F, Fe, Mg, Mn, Mo, Nb, P, S, Si, Sr, Ti, V, W, and Zr.

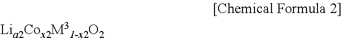

In Chemical Formula 2, 0.9≤a2≤1.8, 0.6≤x2≤1, and M³ is one or more elements selected from a group including AI, B, Ba, Ca, Ce, Cr, Cu, F, Fe, Mg, Mn, Mo, Nb, P, S, Si, Sr, Ti, V, W, and Zr.

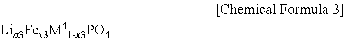

In Chemical Formula 3, 0.9≤a3≤1.8, 0.6≤x3≤1, and M⁴ is one or more elements selected from a group including Al, B, Ba, Ca, Ce, Co, Cr, Cu, F, Fe, Mg, Mn, Mo, Nb, P, S, Si, Sr, Ti, V, W, and Zr.

The average particle diameter D50 of the positive active material may be 1 μm to 25 μm—for example, 3 μm to 25 μm, 5 μm to 25 μm, 5 μm to 20 μm, 8 μm to 20 μm, or 10 μm to 18 μm. The positive active material with these particle diameter ranges may be harmoniously mixed with other components within the positive active material layer and may achieve high-capacity and high-energy density.

The positive active material may be in a form of a secondary particle made by coagulating a plurality of primary particles, or may be in the form of a single particle. Additionally, the positive active material may be a spherical shape or a shape close to a spherical shape, or may be polyhedral or irregular.

### Sulfide-Based Solid Electrolyte

The sulfide-based solid electrolyte may be, for example, Li₂S—P₂S₅, Li₂S—P₂S—LiX (X is a halogen element—for example, I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (m and n are each an integer and Z is Ge, Zn, or Ga), Li₂S—GeS₂, Li₂S—SiS₂—Li₃PO₄, Li₂S—SiS₂-LipMOq (p and q are integers and M is P, Si, Ge, B, Al, Ga, or In), and the like.

The sulfide-based solid electrolyte may be obtained, for example, by mixing Li₂S and P₂S₅ in a mole ratio of about 50:50 to about 90:10 or selectively heat-treating the mixture at a mole ratio of about 50:50 to about 80:20. Within the above mixing ratio range, a sulfide-based solid electrolyte having excellent ionic conductivity may be prepared. The ionic conductivity may be further improved by adding SiS₂, GeS₂, B₂S₃, and the like as other components thereto.

Mechanical milling or a solution method may be applied as a mixing method of a sulfur-containing raw material to produce the sulfide-based solid electrolyte. Mechanical milling is a method of fine-grinding and mixing starting materials into particulates by putting starting materials, ball mills, and the like into a reactor and vigorously stirring them. The solution method may be performed by mixing the starting materials in a solvent to obtain a solid electrolyte as a precipitate. Additionally, if heat treatment is performed after mixing, the solid electrolyte crystals may become stronger and ion conductivity may be improved. For example, the sulfide-based solid electrolyte may be manufactured by mixing the sulfur-including raw materials and heat-treating it more than twice, and in this case, a sulfide-based solid electrolyte with high ion conductivity and robustness may be manufactured.

As an example, the sulfide-based solid electrolyte particle may be an argyrodite-type sulfide. The argyrodite-type sulfide, for example, be expressed as the chemical formula of LiₐM_{b}P_{c}S_{d}Aₑ (a, b, c, d, and e are all 0 or more and 12 or less, M is Ge, Sn, Si or a combination thereof, and A is F, Cl, Br, or I), and as a specific example, may be expressed as the chemical formula of Li₇₋ₓPS₆₋ₓAₓ (X is 0.2 or more and 1.8 or less, and Ais F, Cl, Br, or I). The argyrodite-type sulfide may specifically be Li₃PS₄, Li₇P₃S₁₁, Li₇PS₆, Li₆PS₅Cl, Li₆PS₅Br, Li_{5.8}PS_{4.8}Cl1.2, Li_{6.2}PS_{5.2}Br_{0.8}, etc.

This sulfide-based solid electrolyte including the argyrodite-type sulfide has high ionic conductivity close to about 10⁻⁴ to about 10⁻² S/cm, which is the ionic conductivity of a general liquid electrolyte, at room temperature and thus, may form close coupling between the positive active material and the solid electrolyte without degrading the ion conductivity, and furthermore, form a close interface between the electrode layer and the solid electrolyte layer. An all-solid-state battery including the same may exhibit improved battery performance such as rate capability, Coulomb efficiency, and cycle-life characteristics.

The argyrodite-type sulfide-based solid electrolyte may be produced, for example, by mixing lithium sulfide, phosphorus sulfide, and selectively lithium halide. After mixing them, heat treatment may be performed. The heat treatment may include, for example, two or more heat-treatment steps.

The average particle diameter D50 of the sulfide-based solid electrolyte particle according to one embodiment may be 5.0 μm or less—for example, 0.1 μm to 5.0 μm, 0.1 μm to 4.0 μm, 0.1 μm to 3.0 μm, 0.5 μm to 2.0 μm, or 0.1 μm to 1.5 μm. Alternatively, the sulfide-based solid electrolyte particle may be a small particle with an average particle diameter D50 of 0.1 μm to 1.0 μm, or a large particle with an average particle diameter D50 of 1.5 μm to 5.0 μm, depending on the position or purpose for which it is used. The sulfide-based solid electrolyte particles in this particle diameter range may effectively penetrate between the solid particles within the battery, and have excellent contact with the electrode active material and connectivity between the solid electrolyte particles. The average particle diameter of the sulfide-based solid electrolyte particle may be measured using a microscope image; for example, a particle size distribution may be obtained by measuring the size of about 20 particles in a scanning electron microscope image, and D50 may be calculated from this.

The content of the solid electrolyte in the positive electrode for the all-solid-state battery may be 0.5 wt % to 35 wt %—for example, 1 wt % to 35 wt %, 5 wt % to 30 wt %, 8 wt % to 25 wt %, or 10 wt % to 20 wt %. This is the content of the total weight of the components within the positive electrode, and more specifically, the content of the total weight of the positive active material layer.

In one embodiment, the positive active material layer may include, for 100 wt % of the positive active material layer, 50 wt % to 99.35 wt % of the positive active material, 0.5 wt % to 35 wt % of the sulfide-based solid electrolyte, 0.1 wt % to 10 wt % of a fluorinated resin binder, and 0.05 wt % to 5 wt % of vanadium oxide. If this content range is satisfied, the positive electrode for the all-solid-state rechargeable battery maintains high adherence while implementing high capacity and high ion conductivity, and viscosity of the positive electrode composition is maintained at an appropriate level, thereby improving processability.

### Conductive Material

The positive active material layer may further include a conductive material. The conductive material is included to provide electrode conductivity, and examples of the conductive material may include: a carbon-based material such as natural graphite, artificial graphite, carbon black, acetylene black, Ketjenblack, a carbon fiber, carbon nanotube, and the like; a metal-based material of a metal powder or a metal fiber including copper, nickel, aluminum, silver, and the like; a conductive polymer such as a polyphenylene derivative; or a mixture thereof.

The conductive material may include from 0.1 wt % to 5 wt %, or 0.1 wt % to 3 wt %, with respect to the total weight of each component of the positive electrode for the all-solid-state battery, or with respect to the total weight of the positive active material layer. In the content range, the conductive materials may improve electrical conductivity without degrading battery performance.

When the positive active material layer further includes the conductive material, the positive active material layer, based on the positive active material layer of 100 wt %, may include 45 wt % to 99.25 wt % of the positive active material, 0.5 wt % to 35 wt % of the sulfide-based solid electrolyte, 0.1 wt % to 10 wt % of the fluorinated resin binder, 0.05 wt % to 5 wt % of vanadium oxide, and 0.1 wt % to 5 wt % of the conductive material.

Meanwhile, the positive electrode for the lithium rechargeable battery may further include an oxide-based inorganic solid electrolyte in addition to the solid electrolyte described above. The oxide-based inorganic solid electrolyte, for example, may include Li₁₊ₓTi₂₋ₓAl (PO₄)₃(LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃ (PLZT) (0≤x<1, 0≤y<1), PB (Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y} PO₄₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, garnet-based ceramics Li₃₊ₓLa₃M₂O₁₂ (M=Te, Nb, or Zr; x is an integral of 1 to 10), or a combination thereof.

### All-Solid-State Rechargeable Battery

One embodiment provides an all-solid-state rechargeable battery including the above-described positive electrode, negative electrode, and solid electrolyte layer positioned between the positive electrode and the negative electrode. The all-solid-state rechargeable battery may also be expressed as an all-solid-state battery, or an all-solid-state lithium rechargeable battery.

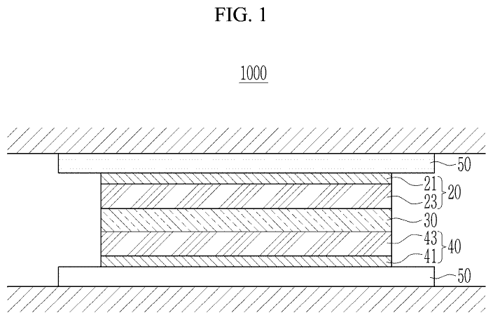

FIG. 1 is a cross-sectional view of an all-solid-state battery.

Referring to FIG. 1, an all-solid-state battery 1000 may be a structure in which an electrode assembly in which a negative electrode 40 including a negative electrode collecting layer 41 and a negative active material layer 43, a solid electrolyte layer 30, and a positive electrode 20 including a positive active material layer 23 and a positive electrode collecting layer 21 are stacked is accommodated in a case such as a pouch or a can. The all-solid-state battery 1000 may further include an elasticity layer 50 outside at least one of the positive electrode 20 and the negative electrode 40. FIG. 1 shows one electrode assembly including the negative electrode 40, the solid electrolyte layer 30, and the positive electrode 20, but an all-solid-state battery may be manufactured by stacking two or more electrode assemblies.

### Negative Electrode

The negative electrode for the all-solid-state battery may include, for example, a current collector and a negative active material layer positioned on the current collector. The negative active material layer includes a negative active material and may further include a binder, a conductive material, and/or a solid electrolyte.

The negative active material includes a material that can perform reversible intercalation and deintercalation of lithium ions, a lithium metal, an alloy of the lithium metal, a material doping or dedoping lithium, or a transition metal oxide.

The material that reversibly intercalates/deintercalates lithium ions may include, for example, crystalline carbon, amorphous carbon, or a combination thereof as a carbon-based negative active material. The crystalline carbon may be natural graphite or artificial graphite in amorphous, plate, flake, spherical, or fiber form, and the amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be an Si-based negative active material or an Sn-based negative active material, and the Si-based negative active material may include silicon, a silicon-carbon composite, SiOₓ (0<x<2), an Si-Q alloy, wherein Q is an alkali metal, an alkaline-earth metal, a Group 13 element, a Group 14 element, a Group 15 element, a Group 16 element, a transition metal, a rare earth element, and a combination thereof, but Si and the Sn-based negative active material may not include Sn, SnO₂, a Sn—R alloy, wherein R is an alkali metal, an alkaline-earth metal, a Group 13 element, a Group 14 element, a Group 15 element, a Group 16 element, a transition metal, a rare earth element, and a combination thereof, but not Sn, and at least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The silicon-carbon composite may be a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, a mesophase pitch, a petroleum-based pitch, a coal-based oil, a petroleum-based heavy oil, or a polymer resin such as a phenol resin, a furan resin, or a polyimide resin. In this case, the content of silicon may be about 10 wt % to about 50 wt % based on the total weight of the silicon-carbon composite. In addition, the content of the crystalline carbon may be about 10 wt % to about 70 wt % based on the total weight of the silicon-carbon composite, and the content of the amorphous carbon may be about 20 wt % to about 40 wt % based on the total weight of the silicon-carbon composite. In addition, a thickness of the amorphous carbon coating layer may be about 5 nm to about 100 nm.

An average particle diameter (D50) of the silicon particles may be about 10 nm to about 20 μm—for example, 10 nm to 500 nm. The silicon particles may exist in an oxidized form, and in this case, an atomic content ratio of Si:O in the silicon particles indicating a degree of oxidation may be a weight ratio of about 99:1 to about 33:67. The silicon particles may be SiOₓ particles, and in this case, the range of x in SiOₓ may be greater than about 0 and less than about 2. Here, the average particle diameter D50 is measured with a particle size analyzer using a laser diffraction method and indicates a particle where an accumulated volume is about 50 vol % in a particle distribution.

The Si-based negative active material or Sn-based negative active material may be mixed with the carbon-based negative active material. When the Si-based negative active material or Sn-based negative active material and the carbon-based negative active material are mixed and used, the mixing ratio may be a weight ratio of about 1:99 to about 10:90.

In the negative active material layer, the negative active material may be in an amount of about 95 wt % to about 99 wt % based on the total weight of the negative active material layer.

In an embodiment, the negative active material layer includes a binder, and may optionally further include a conductive material. The content of the binder in the negative active material layer may be about 1 wt % to about 5 wt % based on the total weight of the negative active material layer. When the conductive material is further included, the negative active material layer may include about 90 wt % to about 98 wt % of the negative active material, about 1 wt % to about 5 wt % of the binder, and about 1 wt % to about 5 wt % of the conductive material.

The binder serves to adhere the negative active material particles to each other and also to adhere the negative active material to the current collector. The binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoroethylene, polyvinylidene fluoride, polyethylene, polypropylene, polyamide-imide, a polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluoro rubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinyl pyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity may be further included. As the cellulose-based compound, one or more of carboxymethyl cellulose, hydroxypropyl methylcellulose, methyl cellulose, or alkali metal salts thereof may be mixed and used. As the alkali metal, Na, K, or Li may be used. The amount of the thickener used may be about 0.1 parts by weight to about 3 parts by weight based on 100 parts by weight of the negative active material.

The conductive material is included to provide electrode conductivity, and any electrically conductive material may be used as a conductive material unless it causes a chemical change; examples of the conductive material include a carbon-based material such as natural graphite, artificial graphite, carbon black, acetylene black, Ketjenblack, a carbon fiber, and the like; a metal-based material of a powder or a fiber including copper, nickel, aluminum, silver, and the like; a conductive polymer such as a polyphenylene derivative; or a mixture thereof.

The current collector may include one selected from a copper foil, a nickel foil, a stainless-steel foil, a titanium foil, a nickel foam, a copper foam, a polymer substrate coated with a conductive metal, and a combination thereof.

On the other hand, the negative electrode for the all-solid-state battery may be, for example, a precipitation-type negative electrode. The precipitation-type negative electrode may be a negative electrode which has no negative active material during the assembly of an electrochemical battery but in which a lithium metal and the like are precipitated during the charge of the electrochemical battery and serve as a negative active material.

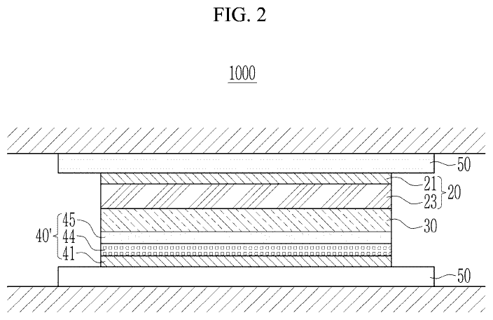

FIG. 2 is a cross-sectional view of an all-solid-state battery including a precipitation-type negative electrode.

Referring to FIG. 2, the precipitation-type negative electrode 40′ may include a current collector 41 and a negative coating layer 45 placed on the current collector 41. The rechargeable lithium battery having this precipitation-type negative electrode 40′ starts to be initially charged in absence of a negative active material, and a lithium metal with high density and the like are precipitated between the current collector 41 and the negative coating layer 45 during the charge and form a lithium metal layer 44, which may work as a negative active material. Accordingly, the precipitation-type negative electrode 40′, in the all-solid-state battery which is charged more than once, may include the current collector 41, the lithium metal layer 44 on the current collector 41, and the negative coating layer 45 disposed on the metal layer. The lithium metal layer 44 means a layer of the lithium metal and the like precipitated during the charge of the electrochemical battery and may be called a metal layer, a negative active material layer, or the like and act as a negative active material.

The negative coating layer 45 includes a metal or a carbon material which plays a role of a catalyst.

The metal may include gold, platinum, palladium, silicon silver, aluminum, bismuth, tin, zinc, or a combination thereof and may be composed of one selected therefrom or an alloy of more than one of these. The metal included in the negative electrode catalyst layer may have an average particle diameter (D50) of less than or equal to about 4 μm—for example, about 10 nm to about 4 μm.

The carbon material may be, for example, crystalline carbon, amorphous carbon, or a combination thereof. The crystalline carbon may be, for example, at least one selected from natural graphite, artificial graphite, mesophase carbon microbeads, and a combination thereof. The amorphous carbon may be at least one selected from carbon black, activated carbon, acetylene black, denka black, Ketjenblack, and a combination thereof.

When the negative coating layer 45 includes the metal and the carbon material, the metal and the carbon material may be, for example, mixed in a weight ratio of about 1:10 to about 2:1. Herein, the precipitation of the lithium metal may be effectively promoted and improve characteristics of the all-solid-state battery. The negative coating layer 45 may include, for example, a carbon material on which a catalyst metal is supported or a mixture of metal particles and carbon material particles.

The negative coating layer 45 may include a metal and an amorphous carbon, for example, and in this case, it may effectively promote the precipitation of the lithium metal.

The negative coating layer 45 may further include a binder, and the binder may be a conductive binder. Also, the negative coating layer 45 may further include general additives such as a filler, a dispersing agent, an ion conductive agent, and the like.

The thickness of the negative coating layer 45 may be, for example, 100 nm to 20 μm, or 500 nm to 10 μm, or 1 μm to 5 μm.

For example, the precipitation-type negative electrode 40′ may further include a thin film on the surface of the current collector 41—that is, between the current collector 41 and the negative coating layer 45. The thin film may include an element capable of forming alloys with lithium. The element capable of forming the alloys with lithium may be, for example, gold, silver, zinc, tin, indium, silicon, aluminum, bismuth, and the like, which may be used alone or as an alloy of more than one. The thin film may further planarize the precipitation pattern of the lithium metal layer 44 and further improve the characteristics of the all-solid-state battery. The thin film may be formed, for example, by methods such as vacuum deposition, sputtering, or plating. The thickness of the thin film may be, for example, 1 nm to 500 nm.

### Solid Electrolyte Layer

The solid electrolyte layer 30 may include a sulfide-based solid electrolyte, an oxide-based solid electrolyte, etc. The specific details of the sulfide-based solid electrolyte and the oxide-based solid electrolyte are described above.

In one example, the solid electrolyte included in the positive electrode 20 and the solid electrolyte included in the solid electrolyte layer 30 may include the same compound or different compounds. For example, if both the positive electrode 20 and the solid electrolyte layer 30 include an argyrodite-type sulfide-based solid electrolyte, the overall performance of the all-solid-state rechargeable battery may be improved. As another example, if both the positive electrode 20 and the solid electrolyte layer 30 include the coated solid electrolyte described above, the all-solid-state rechargeable battery may realize a high-capacity, high-energy density, and excellent initial efficiency and lifespan characteristic.

Meanwhile, the average particle diameter D50 of the solid electrolyte included in the positive electrode 20 may be smaller than the average particle diameter D50 of the solid electrolyte included in the solid electrolyte layer 30. In this case, the overall performance may be improved by maximizing the energy density of the all-solid-state battery and increasing the mobility of lithium ions. For example, the average particle diameter D50 of the solid electrolyte included in the positive electrode 20 may be 0.1 μm to 1.0 μm, or 0.1 μm to 0.8 μm, and the average particle diameter D50 of the solid electrolyte included in the solid electrolyte layer 30 may be 1.5 μm to 5.0 μm, or 2.0 μm to 4.0 μm, or 2.5 μm to 3.5 μm. If these particle diameter ranges are satisfied, the energy density of the all-solid-state rechargeable battery may be maximized and the transferring of lithium ions is easy and then resistance may be suppressed, thereby improving the overall performance of the all-solid-state rechargeable battery. Here, the average particle diameter D50 of the solid electrolyte may be measured through a particle size analyzer using the laser diffraction method. Alternatively, about 20 particles may be selected from a microscope photo such as a scanning electron microscope to measure the particle size and obtain the particle size distribution, and the D50 value may be calculated therefrom.

The solid electrolyte layer may include a binder in addition to the solid electrolyte. Herein, the binder may include a styrene butadiene rubber, polytetrafluoroethylene, polyvinylidene fluoride, polyethylene, an acrylate-based polymer, or a combination thereof, but is not limited thereto. The acrylate-based polymer may be, for example, butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may be isobutyl isobutyrate, xylene, toluene, benzene, hexane, or a combination thereof. Since a forming process of the solid electrolyte layer is well known in the art, a detailed description thereof will be omitted.

The thickness of the solid electrolyte layer may be, for example, about 10 μm to about 150 μm.

The solid electrolyte layer may further include an alkali metal salt and/or an ionic liquid and/or a conductive polymer.

The alkali metal salt may be, for example, lithium salt. The content of lithium salt in the solid electrolyte layer may be 1M or more—for example, 1M to 4M. In this case, the lithium salt may improve ion conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato)borate (LiBOB), lithium oxalyl difluoroborate (LIODFB), lithium difluoro(oxalato) borate (LiDFOB), lithium bis(trifluoromethane sulfonyl)imide (LiTFSI, LiN(SO₂CF₃)₂), lithium bis(fluorosulfonyl)imide, LiFSI, LiN(SO₂F)₂), LiCF₃SO₃, LiAsF₆, LiSbF₆, LiClO₄, or a mixture thereof.

In addition, the lithium salt may be an imide-based salt, for example, the imide-based lithium salt may be lithium bis(trifluoromethane sulfonyl)imide (LiTFSI, LiN(SO₂CF₃)₂), and lithium bis(fluorosulfonyl)imide (LiFSI, LiN(SO₂F)₂). The lithium salt may maintain or improve ionic conductivity by appropriately maintaining chemical reactivity with the ionic liquid.

The ionic liquid has a melting point below room temperature, so it refers to a salt or a room-temperature fusion salt that is liquid at room temperature and consists only of ions.

The ionic liquid may be a compound including a) one or more positive ions selected from ammonium, pyrrolidinium, pyridinium, pyrimidinium, imidazole, piperidinium, pyrazole, oxazole, pyridazinium, phosphonium, sulfonium, and triazole and mixtures thereof, and b) one or more negative ions selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, FSO₂₂N—, (C₂F₅SO₂)₂N—, (C₂F₅SO₂, CF₃SO₂)N—, and (CF₃SO₂)₂N—.

The ionic liquid, for example, may be one or more selected from a group consisting of N-methyl-N-propylpyrrolidinium bis(trifluoromethanesulfonyl)imide, N-butyl-N-methylpyrrolidinium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be about 0.1:99.9 to about 90:10—for example, about 10:90 to about 90:10, about 20:80 to about 90:10, about 30:70 to about 90:10, about 40:60 to about 90:10, or about 50:50 to about 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state battery may be improved.

The all-solid-state rechargeable battery may be a unit cell having a structure of a positive electrode/solid electrolyte layer/negative electrode, a bi-cell having a structure of positive electrode/solid electrolyte layer/negative electrode/solid electrolyte layer/positive electrode, or a stacked battery in which the structure of the unit cell is repeated.

The shape of the all-solid-state battery is not particularly limited, and may be, for example, a coin type, a button type, a sheet type, a stack type, a cylindrical shape, a flat type, and the like. In addition, the all-solid-state battery may be applied to a large-sized battery used in an electric vehicle or the like. For example, the all-solid-state battery may also be used in a hybrid vehicle such as a plug-in hybrid electric vehicle (PHEV). In addition, it may be used in a field requiring a large amount of power storage, and may be used, for example, in an electric bicycle or a power tool.

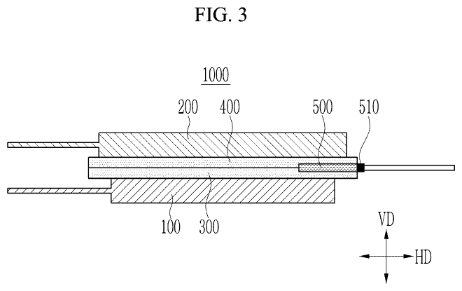

Below, the all-solid-state rechargeable battery according to an embodiment is described with reference to FIG. 3.

FIG. 3 is a cross-sectional view showing an all-solid-state rechargeable battery according to an embodiment.

Referring to FIG. 3, the all-solid-state rechargeable battery 1000 according to an embodiment is a rechargeable battery that may be repeatedly charged and discharged. Hereinafter, the first electrode includes a positive electrode (a cathode) and the second electrode includes a negative electrode (an anode), but is not limited thereto, and the first electrode includes a negative electrode and the second electrode may include a positive electrode.

The all-solid-state rechargeable battery 1000 according to an embodiment includes a first electrode 100, a second electrode 200, a first solid electrolyte layer 300, a second solid electrolyte layer 400, and a reference electrode 500.

The first electrode 100 may include the positive electrode described above, but is not limited thereto. The first electrode may have a plate or a foil shape, but is not limited thereto.

The second electrode 200 is positioned on the first electrode 100. The second electrode 200 may include the negative electrode described above, but is not limited thereto. The second electrode 200 may have a plate or foil form, but is not limited thereto.

The first solid electrolyte layer 300 is positioned between the first electrode 100 and the second electrode 200. The first solid electrolyte layer 300 may include the solid electrolyte layer described above, but is not limited thereto. The first solid electrolyte layer 300 may have a layer form between the first electrode 100 and the second electrode 200, but is not limited thereto.

The second solid electrolyte layer 400 is positioned between the first solid electrolyte layer 300 and the second electrode 200. The second solid electrolyte layer 400 may include the solid electrolyte layer described above, but is not limited thereto. The second solid electrolyte layer 400 may have a layer form between the first electrode 100 and the second electrode 200, but is not limited thereto. The second solid electrolyte layer 400 may include the same material as or a different material from the first solid electrolyte layer 300, but is not limited thereto. The second solid electrolyte layer 400 is in contact with the first solid electrolyte layer 300, and the reference electrode 500 is positioned corresponding to the end of the first solid electrolyte layer 300.

The reference electrode 500 corresponds to the end of the first solid electrolyte layer 300.

For example, the reference electrode may be positioned on the end of the solid electrolyte layer, corresponding to the end of the solid electrolyte layer, or the reference electrode may be positioned below the end of the solid electrolyte layer, corresponding to the end of the solid electrolyte layer, or the reference electrode may be positioned between the ends of the plurality of solid electrolyte layers, corresponding to the ends of the solid electrolyte layer, or the reference electrode may be positioned on an extension extending from the end of the solid electrolyte layer, corresponding to the end of the solid electrolyte layer, or the reference electrode may be positioned below an extension extending from the end of the solid electrolyte layer, corresponding to the end of the solid electrolyte layer, or the reference electrode may be positioned on the tail extending in one direction from the end of the solid electrolyte layer corresponding to the end of the solid electrolyte layer, and then be removed together with the tail after an inspection, or the reference electrode may be positioned below the tail extending in one direction from the end of the solid electrolyte layer, corresponding to the end of the solid electrolyte layer, and is removed together with the tail after an inspection, or the reference electrode may be positioned on the side of the tail extending in one direction from the end of the solid electrolyte layer, corresponding to the end of the solid electrolyte layer, and then removed together with the tail after an inspection, or the reference electrode may be positioned within an imaginary line crossing the end of the solid electrolyte layer in one direction, corresponding to the end of the solid electrolyte layer. The reference electrode may include any of the configurations described above, with the configuration corresponding to the end of the solid electrolyte layer.Ok?

The reference electrode 500 is positioned between the end of the first solid electrolyte layer 300 and the end of the second solid electrolyte layer 400. The reference electrode 500 overlaps the end of the first solid electrolyte layer 300 in a vertical direction VD, where the first electrode 100, the first solid electrolyte layer 300, the second solid electrolyte layer 400, and the second electrode 200 overlap each other. The reference electrode 500 does not overlap the central region of the first solid electrolyte layer 300 or the central region of the second solid electrolyte layer 400 in the vertical direction VD. Here, the end of the first solid electrolyte layer 300 and the end of the second solid electrolyte layer 400 may be, but are not limited to, ends in a horizontal direction HD intersecting the vertical direction VD. Additionally, the central region of the first solid electrolyte layer 300 and the central region of the second solid electrolyte layer 400 may be, but are not limited to, central regions in the horizontal direction HD. The reference electrode 500 may include lithium (Li), but is not limited thereto and may include various known materials. The reference electrode 500 includes an insulating tape 510 adjacent to the end of the first solid electrolyte layer 300 and the end of the second solid electrolyte layer 400, and short circuiting of the reference electrode 500 with the first electrode 100 or the second electrode 200 is suppressed by the insulating tape 510.

In the all-solid-state rechargeable battery 1000 according to an embodiment, each interface between the first electrode 100, the first solid electrolyte layer 300, the second solid electrolyte layer 400, and the second electrode 200 may be closely maintained by pressurization according to the unique characteristics of the all-solid-state rechargeable battery, and the reference electrode 500 overlaps the end of the first solid electrolyte layer 300 and the end of the second solid electrolyte layer 400 in the vertical direction VD between the first solid electrolyte layer 300 and the second solid electrolyte layer 400, whereby short circuiting of the reference electrode 500 with the first electrode 100 or the second electrode 200 is suppressed by pressurization.

Also, in the all-solid-state rechargeable battery 1000 according to an embodiment, by positioning the reference electrode 500 corresponding to the end of the first solid electrolyte layer 300, since the structure in which ions move but electrons do not move is formed between the reference electrode 500 and the first electrode 100, which may be the working electrode and between the reference electrode 500 and the second electrode 200, which may be the counter electrode, the potential of each of the first electrode 100 and the second electrode 200 may be precisely measured using the reference electrode 500, which may keep the potential constant, thereby improving the potential measurement reliability for the all-solid-state rechargeable battery 1000.

That is, the all-solid-state rechargeable battery 1000 is provided that may precisely measure the potential of each of the first electrode 100 and the second electrode 200 by using the reference electrode 500, while simultaneously suppressing the reference electrode 500 from being short circuited with the first electrode 100 or the second electrode 200 even when the space between the first electrode 100 and the second electrode 200 is pressurized.

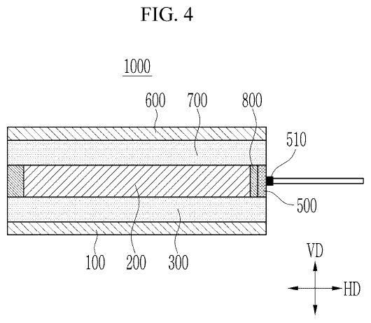

Hereinafter, the all-solid-state rechargeable battery according to another embodiment is described with reference to FIG. 4. Below, differences from the embodiment described above are described.

FIG. 4 is a cross-sectional view showing an all-solid-state rechargeable battery according to another embodiment.

Referring to FIG. 4, an all-solid-state rechargeable battery 1000 according to another embodiment includes a first electrode 100, a second electrode 200, a first solid electrolyte layer 300, a third electrode 600, a third solid electrolyte layer 700, a first gasket 800, and a reference electrode 500.

The first electrode 100 may include the negative electrode described above, but is not limited thereto. The first electrode may have a plate or a foil shape, but is not limited thereto.

The second electrode 200 is positioned on the first electrode 100. The second electrode 200 may include the positive electrode described above, but is not limited thereto. The second electrode 200 may have a plate or a foil form, but is not limited thereto.

The first solid electrolyte layer 300 is positioned between the first electrode 100 and the second electrode 200. The first solid electrolyte layer 300 may include the solid electrolyte layer described above, but is not limited thereto. The first solid electrolyte layer 300 may have a layer form between the first electrode 100 and the second electrode 200, but is not limited thereto.

The third electrode 600 is positioned on the second electrode 200. The third electrode 600 may include the negative electrode described above, but is not limited thereto. The third electrode 600 may have a plate or a foil form, but is not limited thereto.

The third solid electrolyte layer 700 is positioned between the second electrode 200 and the third electrode 600. The third solid electrolyte layer 700 may include the solid electrolyte layer described above, but is not limited thereto. The third solid electrolyte layer 700 may have a layer form between the second electrode 200 and the third electrode 600, but is not limited thereto. The third solid electrolyte layer 700 may include the same material as or a different material from the first solid electrolyte layer 300, but is not limited thereto. The third solid electrolyte layer 700 is in contact with the second electrode 200 and the third electrode 600, and the reference electrode 500 is positioned corresponding to the end of the first solid electrolyte layer 300.

The first gasket 800 surrounds the rim of the second electrode 200. The first gasket 800 has a loop shape that surrounds the edge of the second electrode 200 in a plane, but is not limited thereto. The first gasket 800 includes various known insulating materials.

The reference electrode 500 corresponds to the end of the first solid electrolyte layer 300. The reference electrode 500 is in contact with the first gasket 800 between the end of the first solid electrolyte layer 300 and the end of the third solid electrolyte layer 700. The reference electrode 500 is positioned in the space where the end of the first gasket 800 overlapping the end of the first solid electrolyte layer 300 in the vertical direction VD is cut off, and the reference electrode 500 overlaps the end of the first solid electrolyte layer 300 and the end of the third solid electrolyte layer 700 in the vertical direction VD while being in contact with the first gasket 800. The reference electrode 500 does not overlap the central region of the first solid electrolyte layer 300 or the central region of the third solid electrolyte layer 700 in the vertical direction VD. Here, the end of the first solid electrolyte layer 300 and the end of the third solid electrolyte layer 700 may be, but are not limited to, ends in the horizontal direction HD intersecting the vertical direction VD. Additionally, the central region of the first solid electrolyte layer 300 and the central region of the third solid electrolyte layer 700 may be central regions in the horizontal direction HD, but are not limited thereto. The reference electrode 500 includes an insulating tape 510 adjacent to the end of the first solid electrolyte layer 300 and the end of the third solid electrolyte layer 700, and the insulating tape 510 suppresses the reference electrode 500 from being short circuited with the first electrode 100 or the second electrode 200.

In the all-solid-state rechargeable battery 1000 according to another embodiment, each interface between the first electrode 100, the first solid electrolyte layer 300, the second electrode 200, the third solid electrolyte layer 700, and the third electrode 600 may be closely maintained by pressurization according to the unique characteristics of the all-solid-state rechargeable battery, and the reference electrode 500 is in contact with the first gasket 800 between the end of the first solid electrolyte layer 300 and the end of the third solid electrolyte layer 700, whereby short circuiting of the reference electrode 500 with the first electrode 100, the second electrode 200, or the third electrode 600 is suppressed by pressurization.

Also, in the all-solid-state rechargeable battery 1000 according to another embodiment, by positioning the reference electrode 500 corresponding to the end of the first solid electrolyte layer 300, since the structure in which ions move but electrons do not move is formed between the reference electrode 500, the first electrode 100, the second electrode 200, and the third electrode 600, the potential of each of the first electrode 100, the second electrode 200, and the third electrode 600 may be precisely measured using the reference electrode 500, which may keep the potential constant, thereby improving the potential measurement reliability for the all-solid-state rechargeable battery 1000.

That is, the all-solid-state rechargeable battery 1000 is provided that may precisely measure the potential of each of the first electrode 100, the second electrode 200, and the third electrode 600 using the reference electrode 500, while simultaneously suppressing the reference electrode 500 from being short circuited with the first electrode 100, the second electrode 200, or the third electrode 600 even when the space between the first electrode 100, the second electrode 200, and the third electrode 600 is pressurized.

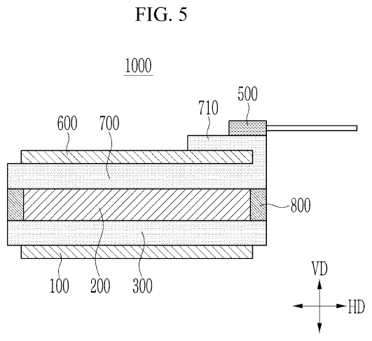

Hereinafter, the all-solid-state rechargeable battery according to another embodiment is described with reference to FIG. 5. Below, differences from the embodiment described above are described.

FIG. 4 is a cross-sectional view showing an all-solid-state rechargeable battery according to another embodiment.

Referring to FIG. 5, an all-solid-state rechargeable battery 1000 according to another embodiment includes a first electrode 100, a second electrode 200, a first solid electrolyte layer 300, a third electrode 600, a third solid electrolyte layer 700, a first gasket 800, and a reference electrode 500.

The first electrode 100 may include the negative electrode described above, but is not limited thereto. The first electrode may have a plate or a foil shape, but is not limited thereto.

The second electrode 200 is positioned on the first electrode 100. The second electrode 200 may include the positive electrode described above, but is not limited thereto. The second electrode 200 may have a plate or a foil form, but is not limited thereto.

The first solid electrolyte layer 300 is positioned between the first electrode 100 and the second electrode 200. The first solid electrolyte layer 300 may include the solid electrolyte layer described above, but is not limited thereto. The first solid electrolyte layer 300 may have a layer form between the first electrode 100 and the second electrode 200, but is not limited thereto.

The third electrode 600 is positioned on the second electrode 200. The third electrode 600 may include the negative electrode described above, but is not limited thereto. The third electrode 600 may have a plate or a foil form, but is not limited thereto.

The third solid electrolyte layer 700 is positioned between the second electrode 200 and the third electrode 600. The third solid electrolyte layer 700 may include the solid electrolyte layer described above, but is not limited thereto. The third solid electrolyte layer 700 may have a layer form between the second electrode 200 and the third electrode 600, but is not limited thereto. The third solid electrolyte layer 700 may include the same material as the first solid electrolyte layer 300 or a different material, but is not limited thereto. The third solid electrolyte layer 700 is in contact with the second electrode 200 and the third electrode 600. The third solid electrolyte layer 700 includes a first extension 710 extending from the rear surface of the third electrode 600, opposite the second electrode 200, through the end of the third electrode 600 in the horizontal direction HD, to the front surface of the third electrode 600. The first extension 710 may be positioned at the uppermost part of the all-solid-state rechargeable battery 1000 in the vertical direction VD corresponding to the end of the first solid electrolyte layer 300, but is not limited thereto.

The first gasket 800 surrounds the rim of the second electrode 200. The first gasket 800 has a loop shape that surrounds the edge of the second electrode 200 in a plane, but is not limited thereto. The first gasket 800 includes various known insulating materials.

The reference electrode 500 corresponds to the end of the first solid electrolyte layer 300. The reference electrode 500 is positioned on the first extension 710 of the third solid electrolyte layer 700. The reference electrode 500 is in contact with the first extension 710. The reference electrode 500 overlaps the end of the first solid electrolyte layer 300 and the end of the third solid electrolyte layer 700 in the vertical direction VD on the first extension 710 of the third solid electrolyte layer 700. The reference electrode 500 does not overlap the central region of the first solid electrolyte layer 300 or the central region of the third solid electrolyte layer 700 in the vertical direction VD. Here, the end of the first solid electrolyte layer 300 and the end of the third solid electrolyte layer 700 may be, but are not limited to, ends in the horizontal direction HD intersecting the vertical direction VD. Additionally, the central region of the first solid electrolyte layer 300 and the central region of the third solid electrolyte layer 700 may be central regions in the horizontal direction HD, but are not limited thereto.

In the all-solid-state rechargeable battery 1000 according to another embodiment, each interface between the first electrode 100, the first solid electrolyte layer 300, the second electrode 200, the third solid electrolyte layer 700, and the third electrode 600 may be closely maintained by pressurization according to the unique characteristics of the all-solid-state rechargeable battery, and the reference electrode 500 is positioned on the first extension 710 of the third solid electrolyte layer 700 corresponding to the end of the first solid electrolyte layer 300, whereby short circuiting of the reference electrode 500 with the first electrode 100, second electrode 200, or third electrode 600 is suppressed by pressurization.

Also, in the all-solid-state rechargeable battery 1000 according to another embodiment, by positioning the reference electrode 500 on the first extension 710 of the third solid electrolyte layer 700 corresponding to the end of the first solid electrolyte layer 300, since the reference electrode 500 and the second electrode 200 and third electrode 600 each have the structure in which ions move but electrons do not move, the potential of each of the second electrode 200 and third electrode 600 may be precisely measured using the reference electrode 500, which may keep the potential constant, thereby improving the potential measurement reliability for the all-solid-state rechargeable battery 1000.

That is, the all-solid-state rechargeable battery 1000 is provided that may precisely measure the potential of each of the positive electrode of the second electrode 200 and the negative electrode of the third electrode 600 using the reference electrode 500, while simultaneously suppressing short circuiting of the reference electrode 500 with the first electrode 100, the second electrode 200, or the third electrode 600 even when the space between the first electrode 100, the second electrode 200, and the third electrode 600 is pressurized.

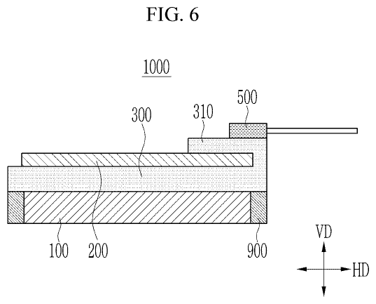

Hereinafter, the all-solid-state rechargeable battery according to another embodiment is described with reference to FIG. 6. Below, differences from the embodiment described above are described.

FIG. 6 is a cross-sectional view showing an all-solid-state rechargeable battery according to another embodiment.

Referring to FIG. 6, an all-solid-state rechargeable battery 1000 according to another embodiment includes a first electrode 100, a second electrode 200, a first solid electrolyte layer 300, a second gasket 900, and a reference electrode 500.

The first electrode 100 may include the positive electrode described above, but is not limited thereto. The first electrode may have a plate or a foil shape, but is not limited thereto.

The second electrode 200 is positioned on the first electrode 100. The second electrode 200 may include the negative electrode described above, but is not limited thereto. The second electrode 200 may have a plate or a foil form, but is not limited thereto.

The first solid electrolyte layer 300 is positioned between the first electrode 100 and the second electrode 200. The first solid electrolyte layer 300 may include the solid electrolyte layer described above, but is not limited thereto. The first solid electrolyte layer 300 may have a layer form between the first electrode 100 and the second electrode 200, but is not limited thereto. The first solid electrolyte layer 300 is in contact with the first electrode 100 and the second electrode 200. The first solid electrolyte layer 300 includes a second extension 310 extending from the rear surface of the second electrode 200 opposite the first electrode 100 through the end of the second electrode 200 in the horizontal direction HD, to the front surface of the second electrode 200. The second extension 310 may be positioned at the uppermost part of the all-solid-state rechargeable battery 1000 in the vertical direction VD corresponding to the end of the first solid electrolyte layer 300, but is not limited thereto.

The second gasket 900 surrounds the perimeter of the first electrode 100. The second gasket 900 has a loop shape that surrounds the perimeter of the first electrode 100 with a flat area, but is not limited thereto. The second gasket 900 includes various known insulating materials.

The reference electrode 500 corresponds to the end of the first solid electrolyte layer 300. The reference electrode 500 is positioned on the second extension 310 of the first solid electrolyte layer 300. The reference electrode 500 is in contact with the second extension 310. The reference electrode 500 overlaps the end of the first solid electrolyte layer 300 in the vertical direction VD on the second extension 310 of the first solid electrolyte layer 300. The reference electrode 500 does not overlap the central region of the first solid electrolyte layer 300 in the vertical direction VD. Here, the end of the first solid electrolyte layer 300 may be an end in the horizontal direction HD intersecting the vertical direction VD, but is not limited thereto. Additionally, the central region of the first solid electrolyte layer 300 may be the central region in the horizontal direction HD, but is not limited thereto.

In the all-solid-state rechargeable battery 1000 according to another embodiment, the interface between the first electrode 100, the first solid electrolyte layer 300, and the second electrode 200 is closely maintained by pressurization according to the unique characteristics of the all-solid-state rechargeable battery and the reference electrode 500 is positioned on the second extension 310 of the first solid electrolyte layer 300 in correspondence with the end of the first solid electrolyte layer 300, whereby short circuiting of the reference electrode 500 with the first electrode 100 or the second electrode 200 is suppressed by pressurization.

Also, in the all-solid-state rechargeable battery 1000 according to another embodiment, by positioning the reference electrode 500 on the second extension 310 of the first solid electrolyte layer 300 corresponding to the end of the first solid electrolyte layer 300, since the space between the reference electrode 500, and the first electrode 100 and second electrode 200 each has a structure in which ions move but electrons do not move, the potential of each of the first electrode 100 and the second electrode 200 is precisely measured using the reference electrode 500 that can keep the potential constant, thereby improving the potential measurement reliability for the all-solid-state rechargeable battery 1000.

That is, the all-solid-state rechargeable battery 1000 is provided that can precisely measure the potential of each of the positive electrode of the first electrode 100, and the negative electrode of the second electrode 200, by using the reference electrode 500, while simultaneously suppressing the reference electrode 500 from being short circuited with the first electrode 100 or the second electrode 200 even if the space between the first electrode 100 and the second electrode 200 is pressurized.

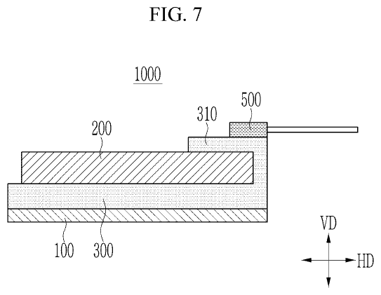

Hereinafter, an all-solid-state rechargeable battery according to another embodiment is described with reference to FIG. 7. Below, the differences from the embodiment described above are described.

FIG. 7 is a cross-sectional view showing an all-solid-state rechargeable battery according to another embodiment.

Referring to FIG. 7, an all-solid-state rechargeable battery 1000 according to another embodiment includes a first electrode 100, a second electrode 200, a first solid electrolyte layer 300, and a reference electrode 500.

The first electrode 100 may include the negative electrode described above, but is not limited thereto. The first electrode may have a plate or a foil shape, but is not limited thereto.

The second electrode 200 is positioned on the first electrode 100. The second electrode 200 may include the positive electrode described above, but is not limited thereto. The second electrode 200 may have a plate or a foil form, but is not limited thereto.

The first solid electrolyte layer 300 is positioned between the first electrode 100 and the second electrode 200. The first solid electrolyte layer 300 may include the solid electrolyte layer described above, but is not limited thereto. The first solid electrolyte layer 300 may have a layer form between the first electrode 100 and the second electrode 200, but is not limited thereto. The first solid electrolyte layer 300 is in contact with the first electrode 100 and the second electrode 200. The first solid electrolyte layer 300 includes a second extension 310 extending from the rear surface of the second electrode 200 opposite the first electrode 100 through the end of the second electrode 200 in the horizontal direction HD, to the front surface of the second electrode 200. The second extension 310 may be positioned at the uppermost part of the all-solid-state rechargeable battery 1000 in the vertical direction VD corresponding to the end of the first solid electrolyte layer 300, but is not limited thereto.

The reference electrode 500 corresponds to the end of the first solid electrolyte layer 300. The reference electrode 500 is positioned on the second extension 310 of the first solid electrolyte layer 300. The reference electrode 500 is in contact with the second extension 310. The reference electrode 500 overlaps the end of the first solid electrolyte layer 300 in the vertical direction VD on the second extension 310 of the first solid electrolyte layer 300. The reference electrode 500 does not overlap the central region of the first solid electrolyte layer 300 in the vertical direction VD. Here, the end of the first solid electrolyte layer 300 may be an end in the horizontal direction HD intersecting the vertical direction VD, but is not limited thereto. Additionally, the central region of the first solid electrolyte layer 300 may be the central region in the horizontal direction HD, but is not limited thereto.

In the all-solid-state rechargeable battery 1000 according to another embodiment, the interface between the first electrode 100, the first solid electrolyte layer 300, and the second electrode 200 is closely maintained by pressurization according to the unique characteristics of the all-solid-state rechargeable battery and the reference electrode 500 is positioned on the second extension 310 of the first solid electrolyte layer 300 in correspondence with the end of the first solid electrolyte layer 300, whereby short circuiting of the reference electrode 500 with the first electrode 100 or the second electrode 200 is suppressed by pressurization.

Also, in the all-solid-state rechargeable battery 1000 according to another embodiment, by positioning the reference electrode 500 on the second extension 310 of the first solid electrolyte layer 300 corresponding to the end of the first solid electrolyte layer 300, since the space between the reference electrode 500, and the first electrode 100 and second electrode 200 each has a structure in which ions move but electrons do not move, the potential of each of the first electrode 100 and the second electrode 200 is precisely measured using the reference electrode 500 that can keep the potential constant, thereby improving the potential measurement reliability for the all-solid-state rechargeable battery 1000.

That is, the all-solid-state rechargeable battery 1000 is provided that can precisely measure the potential of each of the negative electrode of the first electrode 100, and the positive electrode of the second electrode 200, by using the reference electrode 500, while simultaneously suppressing the reference electrode 500 from being short circuited with the first electrode 100 or the second electrode 200 even if the space between the first electrode 100 and the second electrode 200 is pressurized.

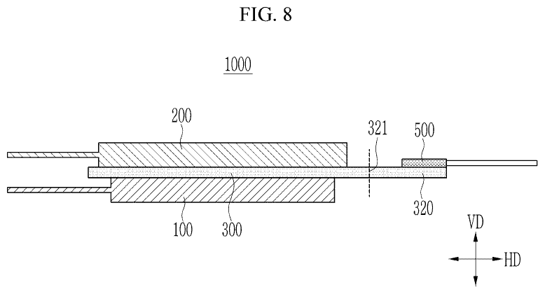

Hereinafter, an all-solid-state rechargeable battery according to another embodiment is described with reference to FIG. 8. Below, the differences from the embodiment described above are described.

FIG. 8 is a cross-sectional view showing an all-solid-state rechargeable battery according to another embodiment.

Referring to FIG. 8, an all-solid-state rechargeable battery 1000 according to another embodiment includes a first electrode 100, a second electrode 200, a first solid electrolyte layer 300, and a reference electrode 500.

The first electrode 100 may include the positive electrode described above, but is not limited thereto. The first electrode may have a plate or a foil shape, but is not limited thereto.

The second electrode 200 is positioned on the first electrode 100. The second electrode 200 may include the negative electrode described above, but is not limited thereto. The second electrode 200 may have a plate or a foil form, but is not limited thereto.

The first solid electrolyte layer 300 is positioned between the first electrode 100 and the second electrode 200. The first solid electrolyte layer 300 may include the solid electrolyte layer described above, but is not limited thereto. The first solid electrolyte layer 300 may have a layer form between the first electrode 100 and the second electrode 200, but is not limited thereto. The first solid electrolyte layer 300 is in contact with the first electrode 100 and the second electrode 200. The first solid electrolyte layer 300 includes a tail 320 extending in a horizontal direction HD intersecting with a vertical direction VD in which the first electrode 100, the first solid electrolyte layer 300, and the second electrode 200 overlap each other. The tail 320 does not overlap the first electrode 100, the first solid electrolyte layer 300, and the second electrode 200 in the vertical direction VD. The tail 320 includes a cutting line 321, and the tail 320 can be cut along the cutting line 321. The tail 320 may be selectively cut from the first solid electrolyte layer 300.

The reference electrode 500 corresponds to the end of the first solid electrolyte layer 300. The reference electrode 500 is in contact with the tail 320. The reference electrode 500 does not overlap the first solid electrolyte layer 300, the first electrode 100, or the second electrode 200 in the vertical direction VD. The reference electrode 500 may be selectively cut along the cutting line 321 from the first solid electrolyte layer 300 along with the tail 320.on the tail 320″ ok?

In the all-solid-state rechargeable battery 1000 according to another embodiment, the interface between the first electrode 100, the first solid electrolyte layer 300, and the second electrode 200 is closely maintained by pressurization according to the unique characteristics of the all-solid-state rechargeable battery and the reference electrode 500, and the reference electrode 500 is in contact with the tail 320 of the first solid electrolyte layer 30, whereby short circuiting of the reference electrode 500 with the first electrode 100 or the second electrode 200 is suppressed by pressurization.on the tail 320″ ok? I realize it's in the original

In addition, in the all-solid-state rechargeable battery 1000 according to another embodiment, by positioning the reference electrode 500 on the tail 320 corresponding to the end of the first solid electrolyte layer 300, since the space between the reference electrode 500 and the first electrode 100 and between the reference electrode 500 and the second electrode 200 each has a structure in which ions move but electrons do not move, the potential of each of the first electrode 100 and the second electrode 200 is precisely measured using the reference electrode 500 that can keep the potential constant, thereby improving the potential measurement reliability for the all-solid-state rechargeable battery 1000.

In addition, in the all-solid-state rechargeable battery 1000 according to another embodiment, since the tail 320 may be selectively cut from the first solid electrolyte layer 300 along the cutting line 321 together with the reference electrode 500, the reference electrode 500 may be easily separated from the all-solid-state rechargeable battery 1000 as needed.

That is, the all-solid-state rechargeable battery 1000 is provided that can precisely measure the potential of each of the first electrode 100, and the second electrode 200, by using the reference electrode 500, while simultaneously suppressing the reference electrode 500 from being short circuited with the first electrode 100 or the second electrode 200 even if the space between the first electrode 100 and the second electrode 200 is pressurized.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

first electrode 100, second electrode 200, first solid electrolyte layer 300, second solid electrolyte layer 400, reference electrode 500

1. An all-solid-state rechargeable battery comprising:
a first electrode;
a second electrode positioned on the first electrode;
a first solid electrolyte layer positioned between the first electrode and the second electrode; and
a reference electrode corresponding to the end of the first solid electrolyte layer.

2. The all-solid-state rechargeable battery as claimed in claim 1, wherein:
the reference electrode overlaps the end of the first solid electrolyte layer in the vertical direction in which the first electrode, the first solid electrolyte layer, and the second electrode overlap each other.

3. The all-solid-state rechargeable battery as claimed in claim 2, wherein:
the reference electrode does not overlap the central region of the first solid electrolyte layer in the vertical direction.

4. The all-solid-state rechargeable battery as claimed in claim 1, further comprising:
a second solid electrolyte layer positioned between the first solid electrolyte layer and the second electrode.

5. The all-solid-state rechargeable battery as claimed in claim 4, wherein:
the reference electrode is positioned between the end of the first solid electrolyte layer and the end of the second solid electrolyte layer.

6. The all-solid-state rechargeable battery as claimed in claim 5, wherein:
the reference electrode includes an insulating tape adjacent to the end of the first solid electrolyte layer and the end of the second solid electrolyte layer.

7. The all-solid-state rechargeable battery as claimed in claim 1, further comprising:
a third electrode positioned on the second electrode; and
a third solid electrolyte layer positioned between the second electrode and the third electrode.

8. The all-solid-state rechargeable battery as claimed in claim 7, further comprising:
a first gasket surrounding the rim of the second electrode.

9. The all-solid-state rechargeable battery as claimed in claim 8, wherein:
the reference electrode is in contact with the first gasket between the end of the first solid electrolyte layer and the end of the third solid electrolyte layer.

10. The all-solid-state rechargeable battery as claimed in claim 9, wherein:
the reference electrode is spaced apart from the second electrode.

11. The all-solid-state rechargeable battery as claimed in claim 7, wherein:
the third solid electrolyte layer includes a first extension extending from the rear surface of the third electrode opposite the second electrode through the end of the third electrode to the front surface of the third electrode, and
the reference electrode is positioned on the first extension.

12. The all-solid-state rechargeable battery as claimed in claim 11, wherein:
the reference electrode is in contact with the first extension.

13. The all-solid-state rechargeable battery as claimed in claim 1, wherein:
the first solid electrolyte layer includes a second extension extending from the rear surface of the second electrode opposite the first electrode through the end of the second electrode to the front surface of the second electrode, and
the reference electrode is positioned on the second extension.

14. The all-solid-state rechargeable battery as claimed in claim 13, wherein:
the reference electrode is in contact with the second extension.

15. The all-solid-state rechargeable battery as claimed in claim 13, further comprising:
a second gasket surrounding the rim of the first electrode.

16. The all-solid-state rechargeable battery as claimed in claim 1, wherein:
the first solid electrolyte layer includes a tail extending in a horizontal direction intersecting the vertical direction in which the first electrode, the first solid electrolyte layer, and the second electrode overlap each other.

17. The all-solid-state rechargeable battery as claimed in claim 16, wherein:
the reference electrode is in contact with the tail.

18. The all-solid-state rechargeable battery as claimed in claim 17, wherein:
the tail includes a cutting line.

19. The all-solid-state rechargeable battery as claimed in claim 1, wherein:
the first electrode is a positive electrode.

20. The all-solid-state rechargeable battery as claimed in claim 1, wherein:
the first electrode is a negative electrode.
